(19) United States
(12) Patent Application Publication
(10) Pub. No.: US 2019/0161331 A1
(43) Pub. Date: May 30, 2019

(54) FORKLIFT ADAPTIVE ACCESSORY

(71) Applicant: Unites States of America as Represented by The Secretary of The Army, Alexandria, VA (US)

(72) Inventors: Omar Esquilin-Mangual, Vicksburg, MS (US); Devin K. Sham, Vicksburg, MS (US)

(21) Appl. No.: 15/824,424

(22) Filed: Nov. 28, 2017

(51) Int. Cl. B66F 9/18; B66F 9/12

(52) U.S. Cl. CPC B66F 9/18; B66F 9/12

(57) ABSTRACT

This invention relates to the field of construction vehicles, and more particularly, to an accessory for extending the capacity of a forklift to accommodate long payloads previously requiring the use of a crane.

### STATEMENT REGARDING FEDERALLY SPONSORED RESEARCH OR DEVELOPMENT

The invention described herein was made by an employee of the United States Government and may be manufactured and used by the Government of the United States of America for governmental purposes without the payment of any royalties thereon or therefore.

### FIELD OF INVENTION

This invention relates to the field of construction vehicles, and more particularly, to an accessory for extending the capacity of a forklifts and cranes.

### BACKGROUND OF THE INVENTION

The Army Corps of Engineers (USACE) continuously develops tactical and civil engineering solutions to protect troops in hostile environments. These solutions include providing rapidly deployed, modular structures to protect assets from harmful projectiles or ballistics.

US Patent No. 2014/0130438 (the '348 patent) teaches a system developed by USACE for rapidly deploying antiballistic shelters that can be constructed from human portable components.

However, it is a problem known in the art that the construction of larger modular facilities requires joists in excess of 30 to 50 feet. Building with structural components of this size generally requires the use of cranes.

Typically, cranes must be rented at a cost of $12,000 to $20,000 per month and shipped to the site. Currently, the government faces a nation-wide shortage of cranes and direct economic competition with the private sector to rent this equipment.

The cost and availability of cranes is a significant problem known in the art for both civilian and military construction projects and results in frequent costs and delays.

There is an unmet need for tooling equipment that can accomplish lifting operations that previously required cranes to facilitate rapid and cost-effective deployment of military and civilian facilities.

### SUMMARY OF THE INVENTION

The invention is a stabilizing tool for use with forklifts and cranes that enables rapid and accurate placement of long construction components partially assembled on the ground. The invention enables use of a forklift to lift long construction components having multiple attachment points which might be destabilized and deformed during lifting and placement.

The stabilizing tool minimizes the number of lifting operations required and provides controlled placement of objects. The invention may be used by a wide range of forklifts and comparable equipment without the need to modify or retrofit the equipment, greatly expanding the functionality and efficiency of forklifts known in the art.

### BRIEF DESCRIPTION OF SEVERAL VIEWS OF THE DRAWING(S)

FIG. 1 illustrates an exemplary forklift adaptive accessory for accurately placing large building components.

FIG. 2 illustrates an exploded view of a forklift adaptive accessory.

FIG. 3 illustrates an exemplary forklift adaptive accessory in use with a forklift.

### TERMS OF ART

As used herein, the term “fixedly attached” means non-removable except during construction.

### Detailed Description of the Invention

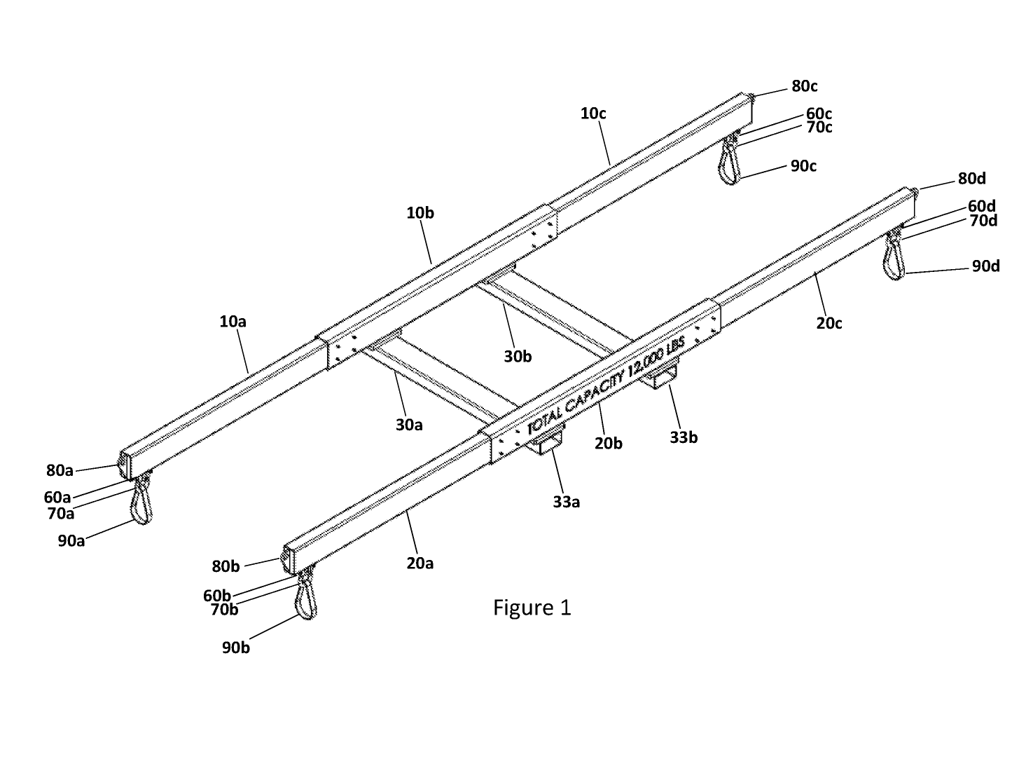

FIG. 1 illustrates exemplary forklift adaptive accessory 100 for accurately placing large building components.

Visible in FIG. 1 are elongated members 10 and 20, central supports 30a and 30b, and rigging components 90a, 90b, 90c, and 90d.

In the embodiment shown, elongated member 10 is comprised of segments 10a, 10b and 10c. Elongated member 20 is comprised of segments 20a, 20b and 20c. Central supports 30a and 30b have open hollow ends 33a and 33b for engaging the forks of a forklift. Central supports 30a and 30b are fixedly attached at a perpendicular orientation to segments 10b and 20b, and are spaced at a distance of 3.5 feet.

In various embodiments, segments 10a and 10c and 20a and 20c may be detached from segments 10b and 20b for storage.

In other embodiments, segments 10a and 10c and 20a and 20c may be telescoping.

Segments 10a, 20a, 10c, and 20c include rigging protuberances 60a, 60b, 60c and 60d with apertures for receiving shackles 70a, 70b, 70c, and 70d.

Shackles 70a, 70b, 70c, and 70d receive rigging components 90a, 90b, 90c, and 90d. In various embodiments, each one of shackles 70a, 70b, 70c, and 70d receive one of rigging components 90a, 90b, 90c, or 90d that engage the lifted object at four distinct attachment points.

In other embodiments, rigging components attach shackle 70a to shackle 70b to form one sling and rigging components attach shackle 70c to shackle 70d to form a second sling; the two slings can accommodate a long object without attachment points, such as a plank or panel.

In various embodiments, more or fewer rigging components may be present.

Rigging components may be cables, ropes, chains, or nylon, provided the total combined capacity of the rigging components is at least 12,000 lbs. In one exemplary embodiment, forklift adaptive accessory 100 includes 4 nylon web straps that are each 2 inches wide and 3 feet long. In this embodiment, the capacity of each of these 4 nylon web straps is 5100 lbs (using a choker hitch knot) or 12,800 lbs (using a basket hitch knot).

In various embodiments, crane protuberances 80a, 80b, 80c and 80d are fixedly attached to segments 10a, 20a, 10c, and 20c by welding. In alternate embodiments, crane protuberances 80a, 80b, 80c and 80d are integrally formed during the manufacturing of segments 10a, 20a, 10c, and 20c.

In various embodiments, crane rigging components must have a combined capacity of at least 12,000 lbs. If there are four crane rigging components and each engages a single crane protuberance 80, then each crane rigging component needs a minimum capacity of 3,000 lbs.

In various embodiments, forklift adaptive accessory 100 operates as a stabilizing tool for use with a forklift that enables rapid and accurate placement of long construction components which generally require the use of a crane. Forklift adaptive accessory 100 provides multiple attachment points for long objects which may bend or deform if portions of more than six feet, up to twenty feet, are left unsupported.

In various embodiments, forklift adaptive accessory 100 provides added support for objects having weakened areas at seams or attachment points. In various embodiments, forklift adaptive accessory 100 may expedite construction of all types of structures by allowing more on-ground assembly and fewer lifting operations.

Forklift adaptive accessory 100 minimizes the number of lifting operations required and provides controlled placement of objects. Forklift adaptive accessory 100 may be used by a wide range of forklifts and comparable equipment without the need to modify or retrofit the equipment, greatly expanding the functionality and efficiency of forklifts known in the art.

In the exemplary embodiment shown, forklift adaptive accessory 100 has a lifting capacity of 12,000 pounds. In the exemplary embodiment shown, forklift adaptive accessory 100 is constructed from high strength steel tubing and weighs 1350 pounds.

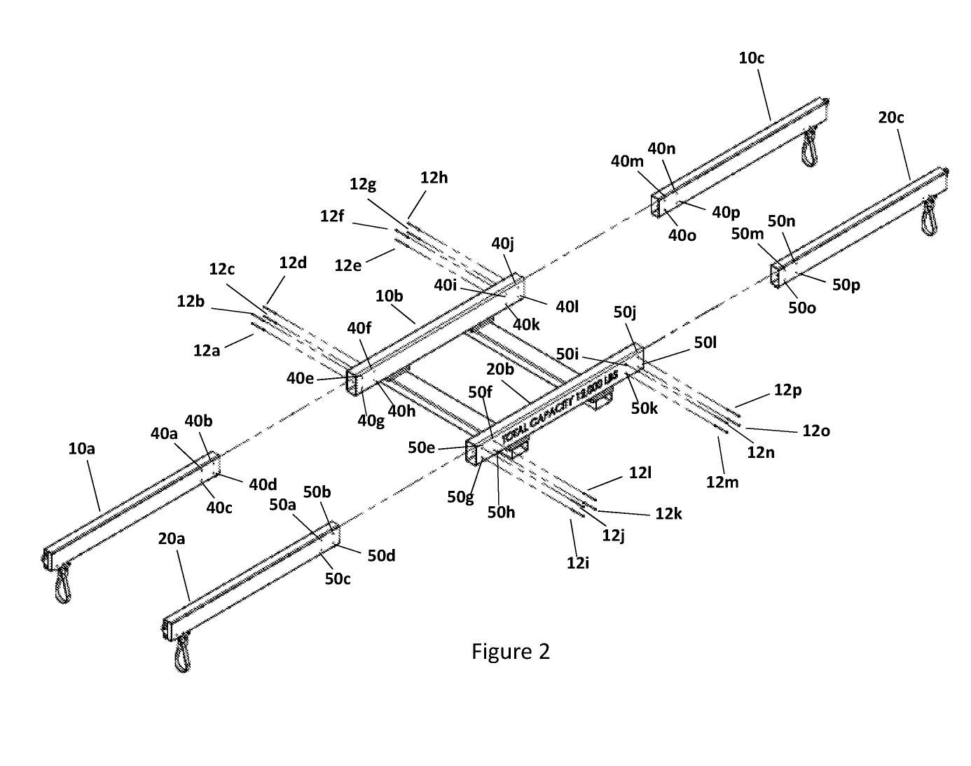

FIG. 2 illustrates an exploded view of forklift adaptive accessory 100. Elongated member 10 is comprised of segments 10a, 10b and 10c.

Segment 10a includes apertures 40a-d, that align with apertures 40 e-h in segment 10b, into which securing pins 12a, 12b, 12c and 12d are inserted.

Segment 10c includes apertures 40m-p, that align with apertures 40 i-l in segment 10b, into which securing pins 12e-h are inserted.

Segment 20a includes apertures 50a-d, that align with apertures 50 e-h in segment 20b, into which securing pins 12i-l are inserted.

Segment 20c includes apertures 50m-p, that align with apertures 50 i-l in segment 20b, into which securing pins 12m-p are inserted.

Other embodiments may include more or fewer securing pins or apertures.

In various embodiments, segments 10a and 10c and 20a and 20c may be detached from segments 10b and 20b for storage.

In other embodiments, segments 10a and 10c and 20a and 20c may be telescoping.

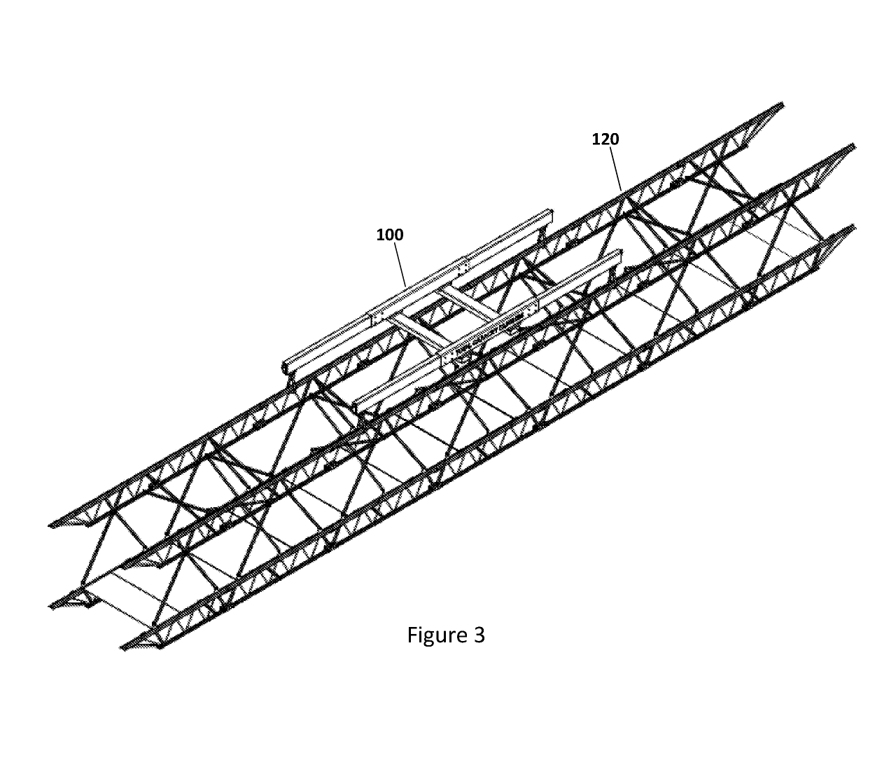

FIG. 3 illustrates exemplary forklift adaptive accessory 100 in use.

FIG. 3 shows forklift adaptive accessory 100 and object 120.

In the exemplary embodiment shown, rigging components connect forklift adaptive accessory 100 to object 120 at four distinct attachment points.

In various embodiments, more or fewer rigging components may be present and the number of attachment points on object 120 may vary.

In various embodiments, object 120 may be as long as 75 feet and may weigh up to 12,000 pounds. In various embodiments, object 120 may be a plank or panel without easily accessible attachment points. Altering the configuration of the rigging components will allow forklift adaptive accessory 100 to lift an object that does not have easily accessible attachment points.

What is claimed is:

1. forklift accessory comprised of:
a plurality of elongated members comprised of a plurality of segments wherein said plurality of segments of said elongated members include apertures into which securing pins are inserted and wherein said apertures of said plurality of segments align and accept said securing pins to secure said plurality of segments; and
central supports wherein said central supports are fixedly attached to said elongated members at a perpendicular orientation and are hollow and have open ends for engaging the forks of a forklift.

2. (canceled)

3. (canceled)

4. The accessory of claim 1, wherein said segments of said elongated members may detach for storage.

5. (canceled)

6. (canceled)

7. The accessory of claim 1, wherein a number of d apertures is greater than a number of said securing pins.

8. The accessory of claim 7, wherein a position of said apertures allows said elongated members to be secured in alternative positions.

9. The accessory of claim 8, wherein said alternative positions produce said elongated members having adjustable length.

10. The accessory of claim 1, wherein said segments include rigging protuberances that have apertures for receiving shackles.

11. The accessory of claim 10, wherein said shackles receive rigging components that engage a lifted object.

12. (canceled)

13. The accessory of claim 11, wherein said lifted object has attachment points.

14. The accessory of claim 11, wherein said lifted object is approximately 25 to 75 feet long.

15. The accessory of claim 11, wherein said lifted object weighs approximately 500 to 12,000 pounds.

16. The accessory of claim 1, wherein said segments include crane protuberances that have apertures.

17. The accessory of claim 16, wherein said apertures receive rigging components that engage a crane.
